(19) United States
(12) Patent Application Publication
(10) Pub. No.: US 2018/0000690 A1
(43) Pub. Date: Jan. 4, 2018

(54) Apparatus for Transferring a Liquid Between a Storage Container and At Least One Further Use Container

(71) Applicant: BAYER PHARMA AKTIENGESELLSCHAFT, Berlin (DE)

(72) Inventors: Gero Eichelkraut, Dresden (DE); Tobias Festel, Sparneck (DE); Frank Skaper, Leupoldsgrün (DE); Martin Bayer, Rödental (DE); Christoph Merhold, Hof (DE)

(21) Appl. No.: 15/546,568

(22) PCT Filed: Jan. 22, 2016
(86) PCT No.: PCT/EP2016/051278

§ 371 Date: Jul. 26, 2017

(30) Foreign Application Priority Data
Jan. 26, 2015 (DE) 10 2015 201 285.9

(51) Int. Cl. A61J 1/20

(52) U.S. Cl. CPC A61J 1/2096; A61J 1/201; A61J 1/2055

(57) ABSTRACT

An apparatus for transferring a liquid between a storage container and at least one further use container has a storage-container sealing portion for leaktight abutment of a main body of the transfer apparatus against the storage container. A hollow-needle assembly has a hollow needle. The hollow-needle assembly can be displaced in a linear manner along a movement axis relative to the main body by means of a gear mechanism between a retracted rest position and an extended connecting position. In the latter, the hollow needle creates a liquid connecting duct between the storage container and the transfer apparatus. A connecting portion serves to connect the transfer apparatus to the use container in a leaktight manner. A rotary-actuation element is operatively connected to the hollow-needle assembly via the gear mechanism. The gear mechanism has a driver ring that is mounted in the main body axially and so as to be rotatable about the movement axis. Said driver ring interacts with a complementary thread of the hollow-needle assembly for the displacement thereof. The driver ring is connected to the rotary-actuation element for conjoint rotation during the displacement. This results in a transfer apparatus having improved operational reliability, in particular when used by inexperienced patients.

### FIELD OF THE INVENTION

The invention relates to an apparatus for transferring a liquid between a storage container and at least one further use container. Furthermore, the invention relates to a set made up of such a transfer apparatus and a storage container.

### BACKGROUND OF THE INVENTION

Apparatuses of this type are known from WO 2011/088471 A1, from WO 2014/152249 A1, from WO 98/32411 A1, from U.S. Pat. No. 6,209,738 B1, from U.S. Pat. No. 6,537,263 B1, from U.S. Pat. No. 5,879,345 and from WO 2012/119225 A1.

### SUMMARY OF THE INVENTION

It is an object of the present invention to develop an apparatus of the type mentioned at the beginning in such a way as to improve the operational reliability thereof, in particular when used by inexperienced patients or by patients with limitations, for example limited motor skills.

According to a first aspect, this object is achieved according to the invention by an apparatus for transferring a liquid between a storage container and at least one further use container, the apparatus having a storage-container sealing portion for leaktight abutment of a main body of the transfer apparatus against the storage container, a hollow-needle assembly with a hollow needle, wherein the hollow-needle assembly is displaceable in a linear manner along a movement axis relative to the main body by means of a gear mechanism between a retracted rest position and an extended connecting position in which the hollow needle creates a liquid connecting duct between the storage container and the transfer apparatus, a connecting portion for connecting the transfer apparatus to the use container in a leaktight manner, a rotary-actuation element which is operatively connected to the hollow-needle assembly via the gear mechanism, wherein the gear mechanism has a driver ring that is mounted in the main body axially and so as to be rotatable about the movement axis, said driver ring interacting with a complementary thread of the hollow-needle assembly for the displacement of the hollow-needle assembly, and being connected to the rotary-actuation element for conjoint rotation during the displacement.

The gear mechanism for displacing the hollow-needle assembly into the connecting position, in which there is a liquid connection between the transfer apparatus and the storage container, having a driver ring, makes it possible for the displacement movement of the hollow-needle assembly to be carried out reliably, this displacement movement being essential for the function of the transfer apparatus. The gear mechanism can be embodied such that a rotation of the rotary-actuation element through more than 180°, for example through 360° or through an even larger circumferential angle, displaces the hollow needle between the rest position and the connecting position. Accordingly, such a displacement movement can be brought about with a comparatively small application of force. The hollow-needle assembly can be guided in the main body in a manner secured against rotation. The drivers on the main body for the one part and on the rotary-actuation element for the other part can be in a disengaged state after the hollow-needle assembly has been displaced into the connecting position, such that the rotary-actuation element is removable from the main body. The driver ring can be embodied such that it is in a state disengaged from the complementary thread of the hollow-needle assembly in the connecting position of the hollow-needle assembly. This prevents the hollow-needle assembly from being undesirably transferred back into the rest position.

An apparatus of this type can be used in particular as a reconstitution device. A pulverulent medicine can then be located in the storage container, said medicine first of all, with the transfer apparatus in the connecting position, being mixed with a solvent via the then-attached use container, and subsequently being transferred, via the transfer apparatus, into the same or a further use container in dissolved form for further use.

The rotary-actuation element represents an interface with the patient for carrying out the rotary actuation. The rotary-actuation element can be embodied in a multipart manner and in particular in two parts. One part of the rotary-actuation element can be designed as an end cap and a further part of the rotary-actuation element can be designed as a coupling element for interacting in an actuating manner with further components of the transfer apparatus. In an alternative embodiment, the rotary-actuation element can also be embodied in one part.

The embodiment according to which the driver ring has at least one inner driver which interacts with the complementary thread, embodied as an external thread, of the hollow-needle assembly allows force to be transferred via an outer circumference of the hollow-needle assembly, with the result that the introduction of force is distributed uniformly. The driver ring can be embodied with an inner driver which is designed as an internal thread or as a plurality of internal-thread segments. This further improves force-transmitting contact between the rotary-actuation element and the hollow-needle assembly via the gear mechanism. A tendency of the hollow-needle assembly to tilt relative to the main body is advantageously reduced or entirely ruled out as a result of the force introduced uniformly over the circumference of the hollow needle assembly.

At least one axial lug via which the rotary-actuation element interacts with an axial receptacle in the driver ring results in the rotary-actuation element being connected to the driver ring securely for conjoint rotation. Provision can be made of a plurality of axial lugs, for example three axial lugs, distributed in the circumferential direction. The at least one axial lug can be integrally moulded on a main body of the rotary-actuation element. At least one portion of the at least one axial lug extends parallel to the displacement movement axis of the hollow-needle assembly.

An embodiment having ribs on the main body, which belong to a device for preventing the hollow-needle assembly from rotating in the main body and simultaneously specify an axial seat of the driver ring results in an elegant double function of the rotation-prevention ribs in the main body of the transfer apparatus.

A further object of the invention is to configure handling of a rotary-actuation element in a transfer apparatus of the type mentioned at the beginning in a more convenient manner.

According to a second aspect, this object is achieved according to the invention by an apparatus for transferring a liquid between a storage container and at least one further use container, the apparatus having a storage-container sealing portion for leaktight abutment of a main body of the transfer apparatus against the storage container, a hollow-needle assembly with a hollow needle, wherein the hollow-needle assembly is displaceable in a linear manner along a movement axis relative to the main body by means of a gear mechanism between a retracted rest position and an extended connecting position in which the hollow needle creates a liquid connecting duct between the storage container and the transfer apparatus, a connecting portion for connecting the transfer apparatus to the use container in a leaktight manner, a rotary-actuation element which is operatively connected to the hollow-needle assembly via the gear mechanism, a seal for sealing off the main body from the rotary-actuation element, wherein the main body has a lifting driver which is embodied such that it interacts with a counterpart lifting driver, embodied in a complementary manner, on the rotary-actuation element in order that the rotary-actuation element is lifted off the main body in a manner relieving the seal during the rotary actuation of the rotary-actuation element.

According to the invention, it has been found that application of actuation force during rotary actuation for displacing the hollow-needle assembly from the rest position into the connecting position is reduced considerably by the rotary-actuation element being lifted off the main body in a manner relieving the seal. This correspondingly increases convenience in the rotary actuation of the hollow-needle displacement. The lifting of the main body for relieving the seal can be coordinated with the rotary actuation via the rotary-actuation element such that a rotary-movement region of the rotary-actuation element, in which the rotary-actuation element is lifted off the main body, does not overlap a further rotary-movement region of the rotary-actuation element, in which the hollow needle of the hollow-needle assembly pierces or punctures a closure body, for example a sealing membrane, for closing the storage container. A non-advantageous addition of surmounting forces for lifting the rotary-actuation element off the main body, i.e. for relieving the seal, for the one part, and for piercing or puncturing the closure body for the other part is avoided as a result. In addition, lifting of the seal can be coordinated with the rotary actuation such that, in analogy for example with a rotatable beverage bottle closure, it is suggested that, via the rotary actuation, the transfer apparatus is opened and thus the liquid transfer function is activated. The seal for sealing off the main body from the rotary-actuation element can be an elastomer seal, for example made of silicone, in particular a silicone lamellar seal, or a hard/hard end face mechanical seal. The seal can have both a radial and an axial seal seat or a radial/axial combined seal seat. By way of the seal for sealing off the main body from the rotary-actuation element, it is possible in particular for an interior space of the main body to be sealed off in a germproof manner. The counterpart lifting driver can be arranged on a coupling sleeve of the rotary-actuation element.

A threaded embodiment of at least one of the drivers, i.e. the lifting driver and/or the counterpart lifting driver, results in reliable force transmission when the rotary-actuation element is lifted off the main body of the transfer apparatus.

An embodiment according to which the lifting driver is embodied as an external thread has the result that the rotary-actuation element is engaged with the main body of the transfer apparatus from the outside via the drivers. The rotary-actuation element can in this case be embodied at the same time as a protective body for the main body of the transfer apparatus.

A locking device for locking the hollow-needle assembly to the main body in the connecting position prevents the hollow-needle assembly from being undesirably displaced back for example into the rest position from the connecting position. This thus ensures that the transfer apparatus, which can be used just once, is closed in a tamper-evident manner.

The transfer apparatus according to the two above-described aspects can also be embodied with other combinations of the features explained above.

The advantages of a set made up of a transfer apparatus according to the invention and a storage container correspond to those which have already been explained above with reference to the transfer apparatus. The set can also include at least one use container, for example in the form of a standard syringe.

Exemplary embodiments of the invention are explained in more detail in the following text with reference to the drawing.

### BRIEF DESCRIPTION OF THE DRAWINGS

FIG. 1 shows a perspective view of an apparatus for transferring a liquid between a storage container and at least one further use container, illustrated in an assembled state before being fitted on the storage container;

FIG. 2 shows an axial longitudinal section through the apparatus according to FIG. 1, illustrated in a ready-for-use sealing position fitted on the storage container, with a hollow-needle assembly in a retracted rest position;

FIG. 3 shows an illustration, similar to FIG. 2, of the transfer apparatus, in which some components have been omitted, furthermore illustrated with the hollow-needle assembly in the rest position;

FIG. 4 shows the transfer device, in an illustration similar to FIG. 3, with the hollow-needle assembly shortly after leaving the rest position in an intermediate position between the rest position and an extended connecting position, wherein the hollow needle creates a liquid connecting duct between the storage container and the transfer apparatus in the connecting position;

FIG. 5 shows the transfer apparatus, in an illustration similar to FIGS. 3 and 4, but with the cover of a rotary-actuation element fitted, in the connecting position, in which it is possible to remove the rotary-actuation element;

FIG. 6 shows the transfer apparatus fitted on the storage container, in a perspective illustration similar to FIG. 1, with the hollow-needle assembly in the connecting position following the removal of the rotary-actuation element;

FIG. 7 shows the transfer apparatus, in an illustration similar to FIG. 5, following the removal of the rotary-actuation element, with indicated flow paths;

FIG. 8a/b each show, in an illustration similar to FIG. 7, an enlarged illustration of flow paths through a liquid duct for transporting liquid through a hollow needle of the hollow-needle assembly (FIG. 8a), for the one part, and through an aeration gas duct for transporting gas through the hollow-needle assembly (FIG. 8b), for the other part;

FIG. 9 shows a perspective and enlarged view of a needle tip at the free needle end of the hollow needle of the hollow-needle assembly, wherein the one gas-duct opening, leading out there, of the aeration gas duct and one of a total of two liquid-duct openings, leading out there, of the liquid duct are visible;

FIG. 10 shows a top view of the needle tip, that is to say seen in the viewing direction X in FIG. 9;

FIG. 11a shows a needle sleeve, surrounding the hollow needle, of the hollow-needle assembly in a bottom view;

FIG. 11b shows a section on line XIb-XIb in FIG. 11a;

FIG. 12 shows the needle sleeve, seen in the opposite viewing direction to the viewing direction in FIG. 11, so that a filter carrier of an air filter (not illustrated) in the gas duct is additionally visible;

FIG. 13a/b each show an alternative embodiment of a hollow-needle assembly, in an illustration similar to FIG. 8b, with an axial duct body, additionally arranged in an annular space between the hollow needle and the needle sleeve, for extending an axial path of the gas duct, wherein FIG. 13a shows an axial section and FIG. 13b shows a perspective axial sectional view;

FIG. 14 shows a further embodiment of a transfer apparatus, in an illustration similar to FIG. 1, but already fitted on the storage container;

FIG. 15 shows the transfer apparatus according to FIG. 14 following axial extension of an external seal securing sleeve for ensuring leaktight abutment of a sealing portion of the transfer apparatus against the storage container;

FIG. 16 shows the transfer apparatus according to FIG. 15 with an inserted locking body for ensuring a retracted rest position of a hollow-needle assembly of the embodiment according to FIG. 14 et seq.;

FIG. 17 shows an axial section through the transfer apparatus according to FIG. 15;

FIG. 18 shows the transfer apparatus according to FIG. 14 et seq., in an illustration similar to FIG. 15, following displacement of the hollow-needle assembly into the extended connecting position;

FIG. 19 shows an axial section through the transfer apparatus according to FIG. 18;

FIG. 20a/b show the transfer apparatus according to FIG. 14 et seq. in the connecting position according to FIGS. 18 and 19 with the seal securing sleeve omitted, wherein a pressure-actuation element of the transfer apparatus has been illustrated in a cutaway manner in order to illustrate a guide device of the pressure-actuation element on a main body of the transfer apparatus;

FIG. 21 shows the transfer apparatus according to FIG. 14 et seq. in the connecting position with the pressure-actuation element removed.

### DESCRIPTION OF AT LEAST ONE PREFERRED EMBODIMENT

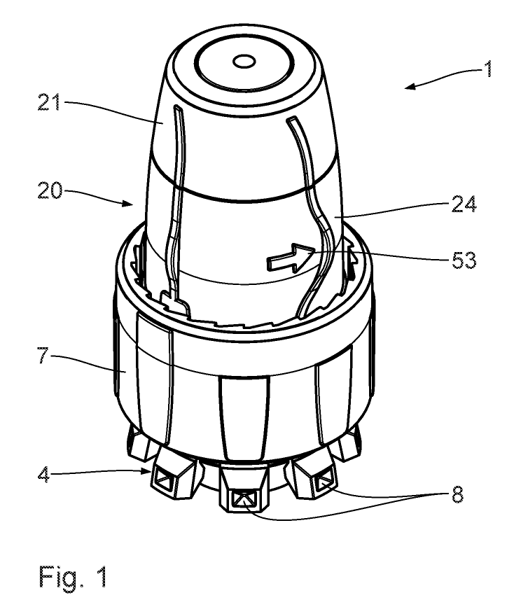

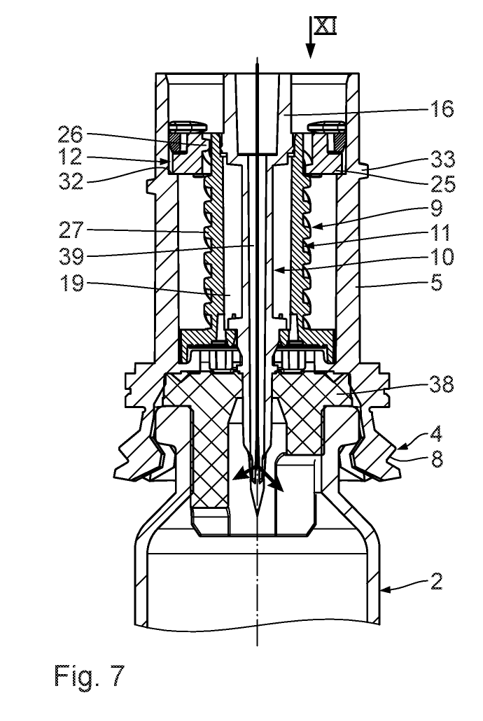

A first embodiment of an apparatus 1 for transferring a liquid between a storage container 2 (cf. FIG. 6) and at least one further storage container 3 (cf. FIG. 6) is described in the following text with reference to FIG. 1 to 12. All the moulded parts of the transfer apparatus 1 are made of plastics material and are embodied in particular as injection-moulded parts.

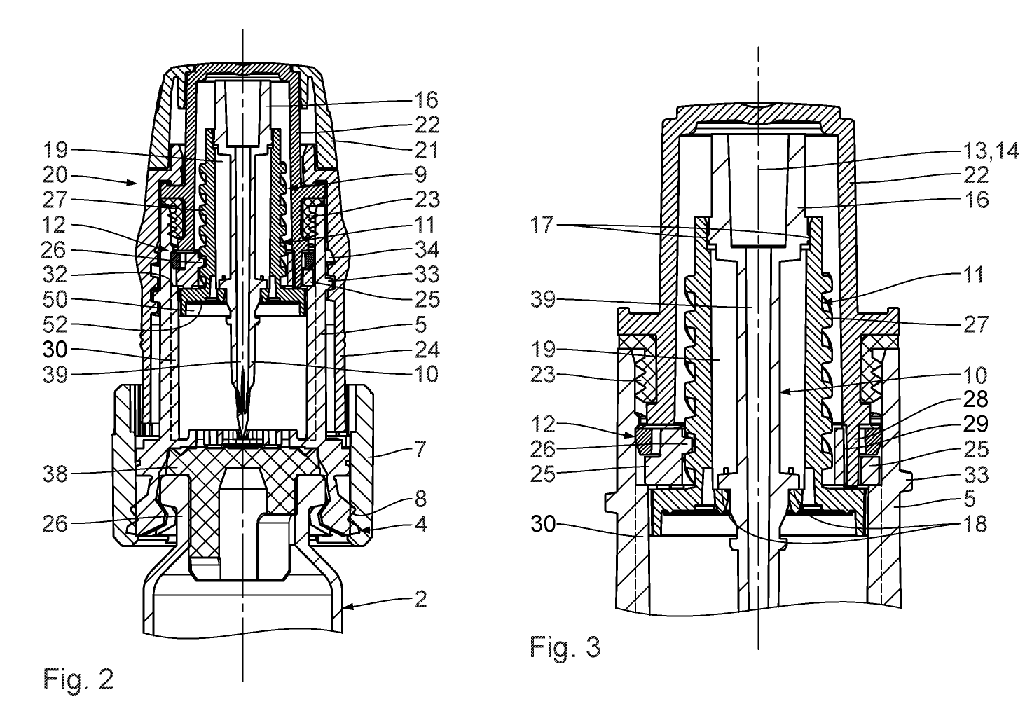

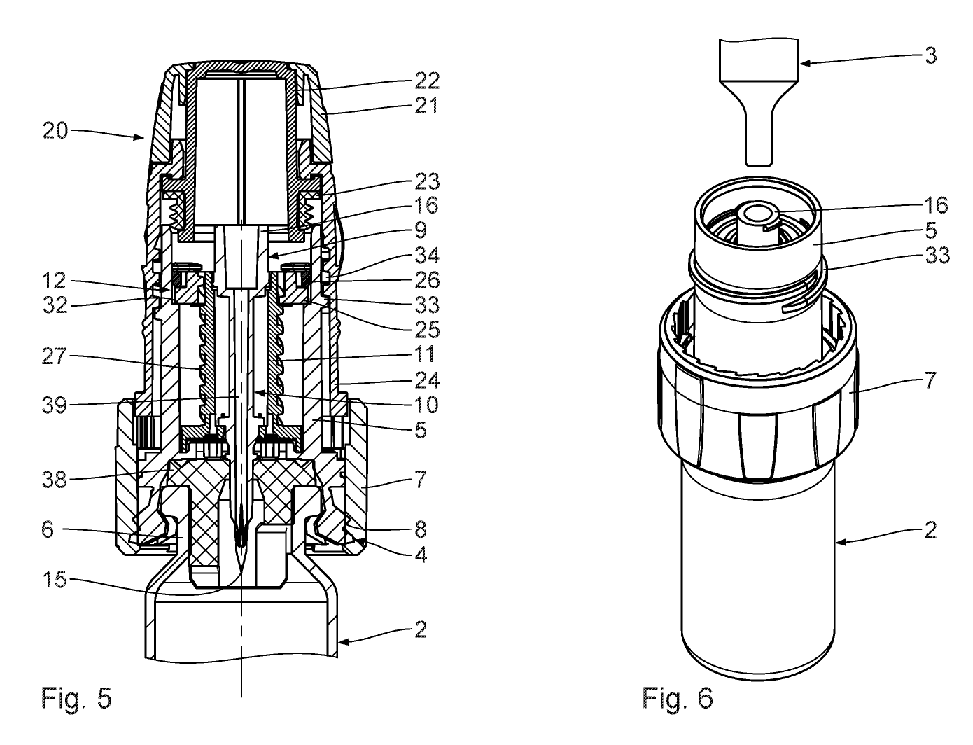

The transfer apparatus 1 has a sealing portion 4 for leaktight abutment of a main body 5 (cf. FIG. 2) of the transfer apparatus 1 against the storage container 2. The sealing portion 4 butts in this case against an elastomeric sealing plug of the storage container 2a, which will be described further in the following text. The sealing portion 4 engages in this case around a neck 6 of the storage container 2 (cf. FIG. 5). An external securing sleeve 7 of the transfer apparatus 1 serves to secure the sealing portion 4 in the sealing position thereof.

FIG. 1 shows the securing sleeve 7 in a transport position of the transfer apparatus 1 before being fitted on the storage container 2. FIG. 6 for example shows the securing sleeve 7 in a securing position in which it is pushed over the sealing portion 4 and in which corresponding latching lugs of the securing sleeve 7 engage in latching receptacles 8 in the sealing portion 4 and press the latter against the neck 6 of the storage container 2 in a leaktight manner.

The transfer apparatus 1 furthermore has a hollow-needle assembly 9 with a hollow needle 10 and a needle sleeve 11 surrounding the latter. The hollow needle 10 is embodied as a plastics hollow needle. Alternatively, the hollow needle 10 can also be embodied at least in part as a steel cannula. Liquid is transferred between the use container 3 and the storage container 2 through the hollow needle 10 and at the same time ventilation and venting of these containers 2, 3 takes place, as will be explained in more detail in the following text.

The hollow-needle assembly 9 is displaceable in a linear manner along a movement axis 13 (cf. FIG. 3) relative to the main body 5 by means of a gear mechanism 12. This movement axis 13 extends coaxially with a longitudinal centre axis 14 of the transfer apparatus 1.

The hollow-needle assembly 9 is displaced between a retracted rest position, illustrated for example in FIGS. 2 and 3, and an extended connecting position, illustrated for example in FIG. 5. In the connecting position, the hollow needle 10 creates inter alia a liquid connecting duct between the storage container 2 and the transfer apparatus 1. This liquid duct extends between a free needle end 15 and an opposite connecting portion 16 (cf. FIG. 5). The connecting portion 16 is an integral constituent part of the hollow needle 10. The connecting portion 16 serves to seal the connection of the transfer apparatus 1 to the use container 3 and is embodied as a Luer connection. In a corresponding manner, the use container 3 is designed as a standard syringe with a complementary Luer connector. As an alternative to a Luer connection, the transfer apparatus 1 can also be connected to the use container 3 in some other way, for example via a different embodiment of a conical connection.

The needle sleeve 11 represents a separate component from the hollow needle 10. The needle sleeve 11 is connected to the hollow needle 10 in a circumferentially leaktight manner in two axial positions, specifically in the region of an end of the needle sleeve 11 that faces the connecting portion 16 (cf. connecting region 17 in FIG. 3), for the one part, and axially spaced apart in an opposite connecting region 18, for the other part. An approximately hollow-cylindrical annular space 19 is located axially between these connecting regions 17, 18 and radially between the hollow needle 10 and the needle sleeve 11.

The transfer apparatus 1 furthermore has a multipart rotary-actuation element 20 which is operatively connected to the hollow-needle assembly 9 via the gear mechanism 12.

The rotary-actuation element 20 has an annular cover 21 and an actuation-element main body 22 (cf. for example FIGS. 2 and 3). The rotary-actuation element 20 is rotatable about the longitudinal centre axis 14 relative to the main body 5 of the transfer apparatus 1.

The actuation-element main body 22 is sealed off from the main body 5 of the transfer apparatus 1 via a main-body seal 23 (cf. for example FIG. 2). This results in a closed-off and in particular germproof space within the main body.

The rotary-actuation element 20 furthermore includes an external coupling sleeve 24 which is connected to the actuation-element main body 22 for conjoint rotation and can be understood to be a constituent part of this main body 22.

The gear mechanism 12 has a driver ring 25 that is mounted in the main body 5 of the transfer apparatus 1 axially and so as to be rotatable about the longitudinal centre axis 14. Radially, the driver ring 25 is located between the main body 5 and the needle sleeve 11.

The driver ring 25 has an inner driver which is designed as an internal thread 26 in the embodiment shown. The internal thread 26 interacts with a complementary thread 27, embodied as an external thread, on the needle sleeve 11 in order to displace the hollow-needle assembly 9.

During the displacement of the hollow-needle assembly 9 from the rest position into the connecting position, the driver ring 25 is connected to the rotary-actuation element 20 for conjoint rotation. To this end, the actuation-element main body 22 has a plurality of, for example three, axial lugs 28 (cf. for example FIG. 3) which, as long as the actuation-element main body 22 is connected to the driver ring 25 for conjoint rotation, engage in associated axial receptacles 29 in the driver ring 25. The axial lugs 28 and the associated axial receptacles 29 are distributed about the longitudinal centre axis 14 in the circumferential direction. The axial lugs 28 are integral constituent parts of the actuation-element main body 22.

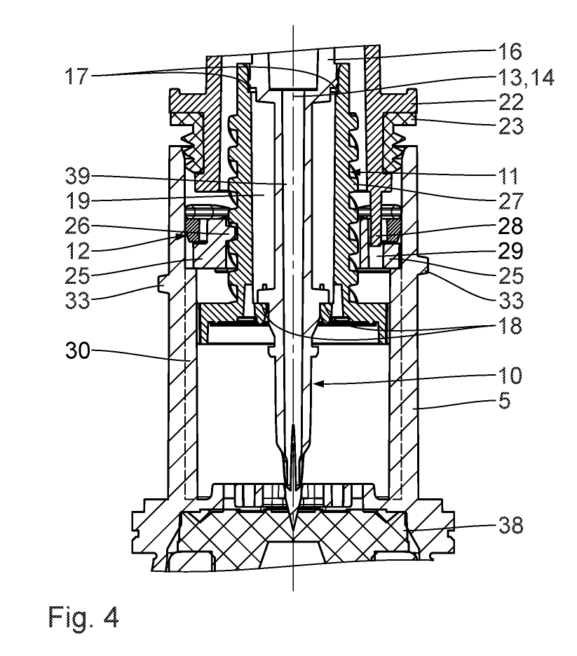

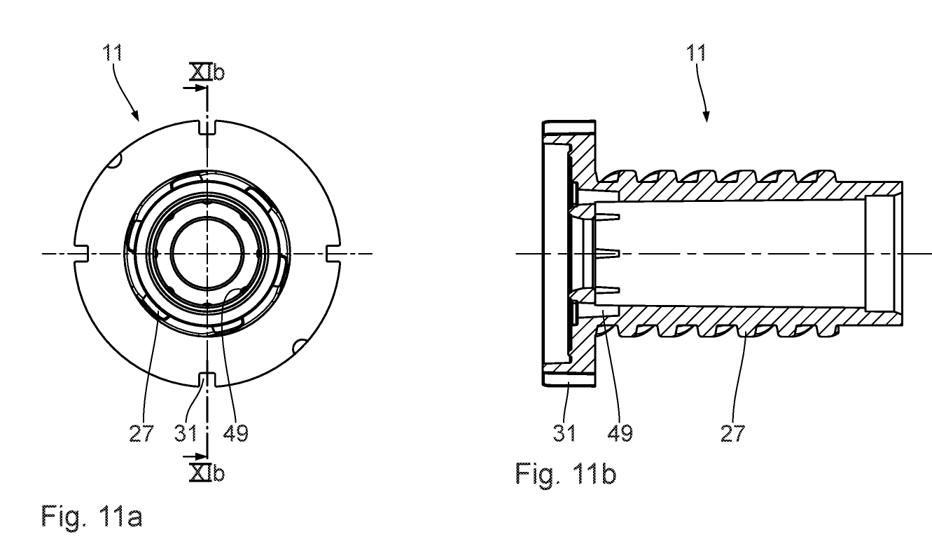

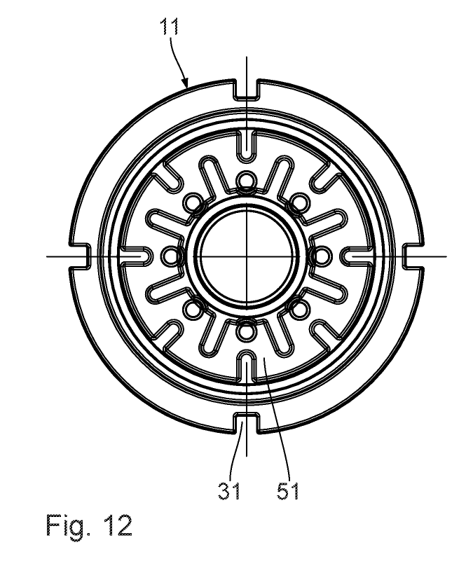

The hollow-needle assembly 9 is prevented from rotating relative to the main body 5 about the longitudinal centre axis 14 via inner axial ribs 30 (cf. for example FIG. 4) which are embodied in the main body 5 of the transfer apparatus 1. To this end, the needle sleeve 11 has axial guide grooves 31 (cf. for example FIG. 11a and 12) complementary to the axial ribs 30.

End sides 32 of these inner axial ribs 30 simultaneously represent an axial seat of the driver ring 25 in the main body 5 of the transfer apparatus.

The main body 5 of the transfer apparatus 1 has a lifting driver 33 embodied as an external thread. Said lifting driver 33 interacts with a counterpart lifting driver 34, embodied as a complementary internal thread, on the coupling sleeve 24 of the rotary-actuation element 20. During the rotary actuation of the rotary-actuation element 20, which brings about the displacement of the hollow-needle assembly 9 from the rest position into the connecting position, the interaction of the lifting driver 33 with the counterpart lifting driver 34 results in the rotary-actuation element 20 being lifted off the main body 5 of the transfer apparatus 1 in order to relieve the main-body seal 23. FIG. 4 shows for example the correspondingly relieved position, in which the actuation-element main body 22 has been lifted axially off the main body 5.

The main-body seal 23 can be embodied as a silicone lamellar seal. Alternatively, the main-body seal 23 can be embodied as a hard/hard end face mechanical seal.

In the connecting position (cf. FIG. 5), the drivers 33, 34 are in a disengaged state, and so the entire rotary-actuation element 20 is removable from the main body 5 of the transfer apparatus 1.

The transfer apparatus 1 additionally has a locking device 35 for locking the hollow-needle assembly 9 in the connecting position. This locking serves to secure the transfer apparatus 1 in a tamper-evident manner, in that the displacement of the hollow-needle assembly 9 into the connecting position is designed to be irreversible. The locking device 35 comprises a latching component 36 on the main body 5 of the transfer apparatus 1, which interacts in a latching manner with a complementary counter-part latching component 37 on the outer wall of the hollow needle 10.

FIG. 6 shows the transfer apparatus 1 with the hollow-needle assembly 9 in the connecting position with the rotary-actuation element 20 removed. The connecting portion 16 of the hollow-needle assembly 9 is now accessible from above and no longer covered by the annular cover 21 of the rotary-actuation element 20. On account of this accessibility of the connecting portion 16, the latter can be connected to the Luer connector of the use container 3.

The storage container 9 is closed in a leaktight manner in the region of its neck 6 by a closure plug 38 in the form of an elastomeric sealing plug or of a sealing membrane. It can be gathered for example from FIGS. 5, 7 and 8a/b that the hollow needle 10 has punctured the storage container 2 or the closure plug 38 of the storage container 2 in the connecting position.

In the region of the free needle end 15, the liquid duct 39, already mentioned above in conjunction with the displacement of the hollow-needle assembly 9, between the storage container 2 and the transfer apparatus 1 leads out via two liquid-duct openings 40, 41 (cf. FIG. 10). The liquid duct 39 serves to transport liquid through the hollow needle 10.

In the region of the free needle end 15, an aeration gas duct 42 additionally leads out of the hollow needle 10 via a gas-duct opening 43. The aeration gas duct 42 serves to transport gas through the hollow-needle assembly 9, specifically in order to ventilate or vent the storage container 2 or the use container 3, respectively.

The duct paths of the liquid duct 39 for the one part and of the gas duct 42 for the other part extend separately from one another. The liquid duct 39 for the one part and the gas duct 42 for the other part lead out adjacently to one another axially along the hollow needle 10 and in a manner offset from one another in the circumferential direction about the longitudinal centre axis 14. A needle separating edge 44, 45 that extends in the longitudinal direction of the hollow needle 10 extends between in each case one of the liquid-duct openings 40, 41 and the adjacent gas-duct opening 43 in the circumferential direction. A further needle separating edge 46 that extends in a corresponding manner in the longitudinal direction of the hollow needle 10 extends between the two liquid-duct openings 40 and 41.

The two needle separating edges 44, 45 between the liquid-duct openings 40, 41 and the gas-duct opening 43 reduce an undesired transfer of liquid between the liquid duct 39 and the aeration gas duct 42. In addition, the needle separating edges 44 to 46 serve to reduce piercing forces of the hollow needle 12 into the closure plug 38 of the storage container 2. The needle separating edges 44 to 46 have a cutting action during the piercing of the closure plug 38.

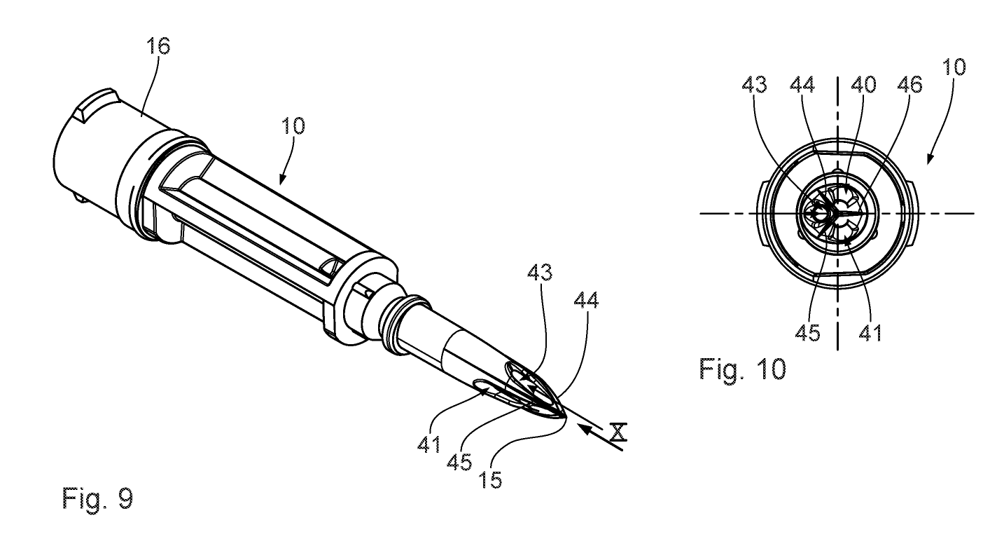

The liquid-duct openings 40, 41 are at least as far away axially from the needle tip at the free needle end 15 as the gas-duct opening 43. In the exemplary embodiment illustrated (cf. FIG. 9), the liquid-duct openings 40, 41 are much further away axially from the needle tip at the free needle end 15 than the gas-duct opening 43.

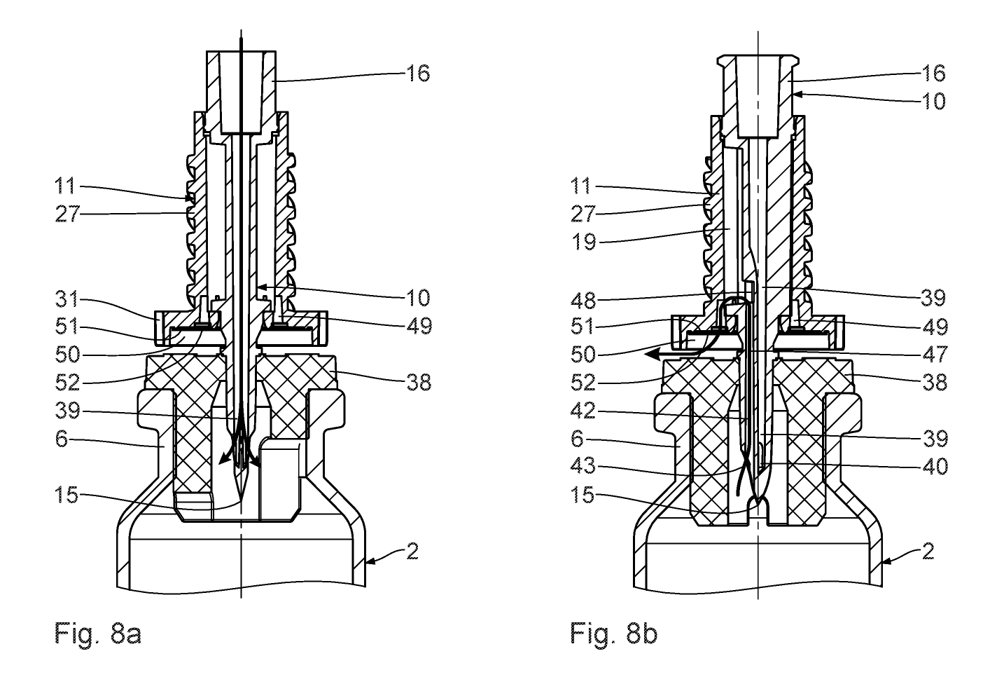

Starting from the gas-duct opening 43, a gas flow path extends through the aeration gas duct 42 first of all via a gas-duct portion 47 which extends parallel to the longitudinal centre axis 14 in the hollow needle 10. The gas-duct portion 47 leads out into the annular space 19 between the hollow needle 10 and the needle sleeve 11 via a passage opening 48 (cf. FIG. 8a/b). The annular space 19 thus forms a portion of the aeration gas duct 42.

At the bottom of the annular space 19, the needle sleeve 11 has a plurality of needle-sleeve passage openings 49. A total of eight such needle-sleeve passage openings 49 are arranged in a manner distributed evenly around the longitudinal centre axis 14. The needle-sleeve passage openings 49 represent a flow passage for the aeration gas duct 42 between the annular space 19 and a further annular space 50 in a portion of the needle sleeve 11 at the bottom, i.e. facing the storage container 2. Arranged in this further annular space 50 is a filter carrier 51 which is in the form of an annular disc and annularly surrounds the hollow needle 10. The filter carrier 51 carries a likewise annular air filter 52 of the transfer apparatus 1. In the further flow path of the aeration gas duct 42, after passing through the air filter 52, it is possible for gas to pass between the needle sleeve 11 and the main body 5 of the transfer apparatus 1 and from there to the outer environment.

In the aeration gas duct 42, a reversal of an axial main gas flow direction takes place between the gas-duct portion 47 and the further gas-duct portion between the needle-sleeve passage openings 49 and the air filter 52 in the region of the annular space 19. Axial flow components in these two gas-duct portions run in a manner precisely opposed to one another. The annular space 19 therefore represents a direction-reversal duct portion of the aeration gas duct 42.

The transfer apparatus 1 is used as follows:

First of all, the transfer apparatus 1 is fitted, in the configuration presented in FIG. 1, on the neck 6 of the storage container 2, in which a for example pulverulent medicine is present. Subsequently, the seal securing sleeve 7 is pushed over the sealing portion 4. As a result, the transfer apparatus 1 is secured on the neck 6 of the storage container 2, wherein, in particular a tamper-evident closure can be ensured. In addition, as a result of the seal securing sleeve 7 being pushed over the sealing portion 4, this sealing portion 4 is secured and seals the transfer apparatus 1 off from the storage container 2. Now, the rotary-actuation element 20 is rotated in the direction of rotation, indicated on the outer side of the annular cover 21 by arrow symbols 53, through 360° or an even greater rotational angle. In this case, the axial lugs 28 carry along the driver ring 25 which, mounted axially in the main body 5, now likewise rotates about the longitudinal centre axis 14, but is not in the process displaced axially with respect to the main body 5. The driver ring 25 is in this case secured axially via undercuts in the main body 5. As a result of the interaction of the threads 26, 27, the displacement of the hollow-needle assembly 9 relative to the main body 5 in the direction of the movement axis 13, i.e. towards the storage container 2, now starts. At the same time, the threads 33, 34 on the main body 5 of the transfer apparatus 1 for the one part and on the coupling sleeve 24 for the other part interact, such that the actuating-element main body 22 is lifted axially off the main body 5 of the transfer apparatus 1, as is illustrated in FIG. 4. On continued rotation of the rotary-actuation element 20, the hollow-needle assembly 9 is displaced into the connecting position according to FIG. 5 and punctures the closure plug 38 of the storage container 2. This takes place until the threads 26, 27 for the one part and the threads 33, 34 for the other part are disengaged from one another. In the connecting position, the locking device 35 is latched in place and the hollow-needle assembly 9 is irreversibly secured in this position.

Now, the entire rotary-actuation element 20 can be removed and the use container 3, i.e. the standard injection syringe, can be connected to the connecting portion 16 of the transfer apparatus 1 via the Luer coupling. A solvent matched to the medicine in the storage container 2 is present in the use container 3. This solvent is now injected into the interior of the storage container 2 via the transfer apparatus 1 by actuation of a syringe piston of the use container 3. In the process, the solvent flows through the liquid duct 39 in the hollow needle 10 and passes out of the hollow needle 10 into the storage container 2 via the two liquid-duct openings 40, 41. The arrangement of the liquid-duct openings 40, 41 relative to the gas-duct opening 43 reduces an overflow of liquid droplets into the gas duct during injection, since the liquid flows downwards in the direction of gravitational force and thus does not flow in the direction of the gas duct during injection. In a manner corresponding to the volume of the liquid entering the storage container 2, air escapes to the outside from the storage container 2 via the gas-duct opening 43 through the aeration gas duct 42 via the gas-duct portion 47, the passage opening 48, the annular space 19, the needle-sleeve passage openings 49, the annular space 50, the air filter 52 and from there between the needle sleeve 11 and the main body 5 of the transfer apparatus 1. The configuration of the free needle end 15 with the needle separating edges 44, 45, the arrangement of the duct openings 40, 41, 43 and the design of the aeration gas duct 42, in particular the reversal of direction in the annular space 19, effectively avoid the situation in which liquid undesirably passes to the outside via the aeration gas duct 42. Liquid droplets that possibly enter the aeration gas duct 42 are dissipated. In particular, the air filter 52 is effectively prevented from becoming clogged with liquid as a result.

After all of the solvent has been injected into the storage container 2, a solution of the initially pulverulent medicine in the solvent is established by shaking the assembly made up of the storage container 2, the transfer apparatus 1 and the use container 3. After dissolution has taken place, the dissolved medicine is transferred into the use container 3 from the storage container 2 via the transfer apparatus 1. In the process, the dissolved medicine flows into the use container 3 via the liquid duct 39 through the hollow needle 10 to the storage container 2. This flow of the dissolved medicine into the use container 3 is established by filling the use container 3 embodied as a syringe. The transfer of the dissolved medicine from the storage container 2 into the use container 3 generally takes place in an upside-down position, in which the storage container 2 is arranged above the use container 3. In this position, the liquid-duct openings 40, 41 are located closer to a residual solution of the dissolved medicine, such as to improve the emptying of residual solution. Moreover, the gas-duct opening 43 is further away from the residual solution than the liquid-duct openings 40, 41 in this upside-down position, such that the gas duct can readily fulfil its ventilation function. In a manner corresponding to the liquid volume emerging from the storage container 2, air flows into the storage container 2 through the aeration gas duct 42 from the environment around the transfer apparatus 1 through the air filter 52. The air flowing in is filtered sterile by the air filter 52.

After the syringe piston of the use container 3 has been drawn back fully, the dissolved medicine is present in the interior of the use container and the use container 3 can then be pulled off the connecting portion 16 of the transfer apparatus 1.

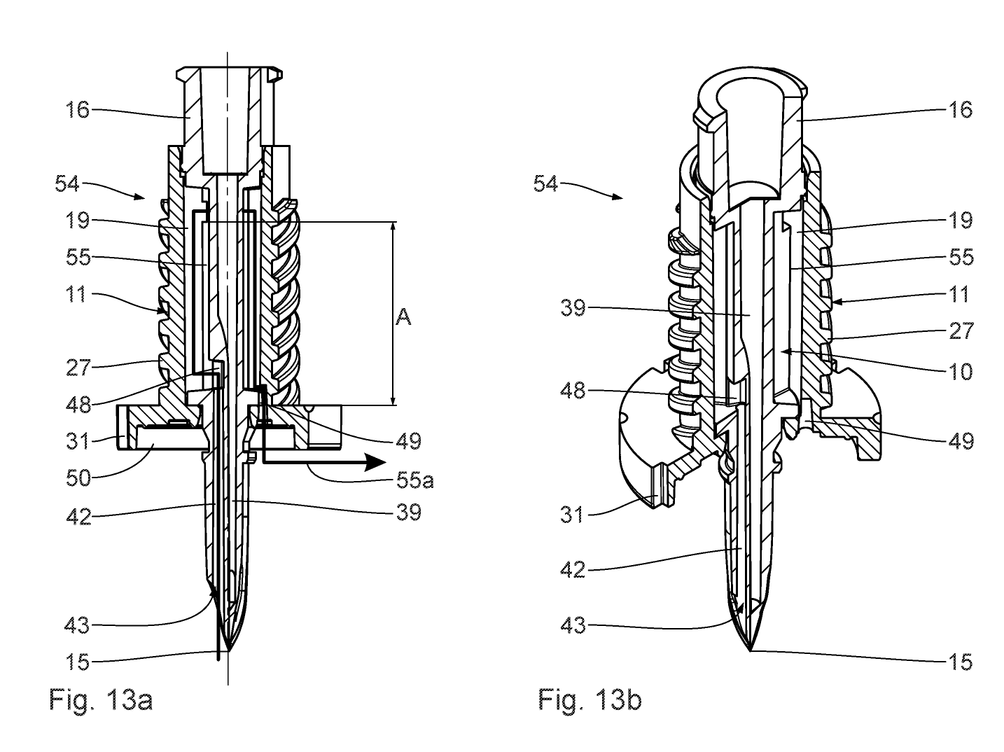

FIGS. 13a and 13b show a variant of a hollow-needle assembly 54 which can be used in the transfer apparatus 1 instead of the hollow-needle assembly 9. Components and functions which correspond to those which have already been explained above with reference to the embodiment according to FIG. 1 to 12 bear the same reference numerals and designations and are not discussed in detail again.

In the hollow-needle assembly 54 according to FIG. 13a/b, an axial-duct body 55 is arranged in the annular space 19. Said axial-duct body 55 is embodied such that a reversal in direction of the aeration gas duct 42 does not take place, as in the embodiment according to FIG. 1 to 12, in the bottom region, facing the storage container 2, of the annular space 19, but approximately at an axial height A of approximately two thirds of the overall axial height of the annular space 19. Upstream of the reversal-direction duct portion, the axial-duct body 55 brings about a corresponding extension of an axial path of the aeration gas duct 42. The axial-duct body 55 effectively suppresses undesired entrainment of liquid along the entire aeration gas duct 42. The path of the gas through the gas duct 42 during venting of the storage container 2 is indicated by a direction arrow 55a in FIG. 13a.

The axial-duct body 55 is embodied as a subsegment between the hollow needle 10 and the needle sleeve 11, said subsegment being sealed off up to a height of two thirds of the overall axial height of the annular space 19. In this subsegment, the passage openings 48 are closed, thereby forcing the air flowing out of the storage container 2 to rise during the injection of the liquid into the storage container 2. The air then flows, after rising and reversing direction, through the remaining passage openings 48 in the non-closed segment. During the extended axial rising path of the aeration gas duct 42, liquid droplets flowing in are additionally dissipated or separated via gravitational force.

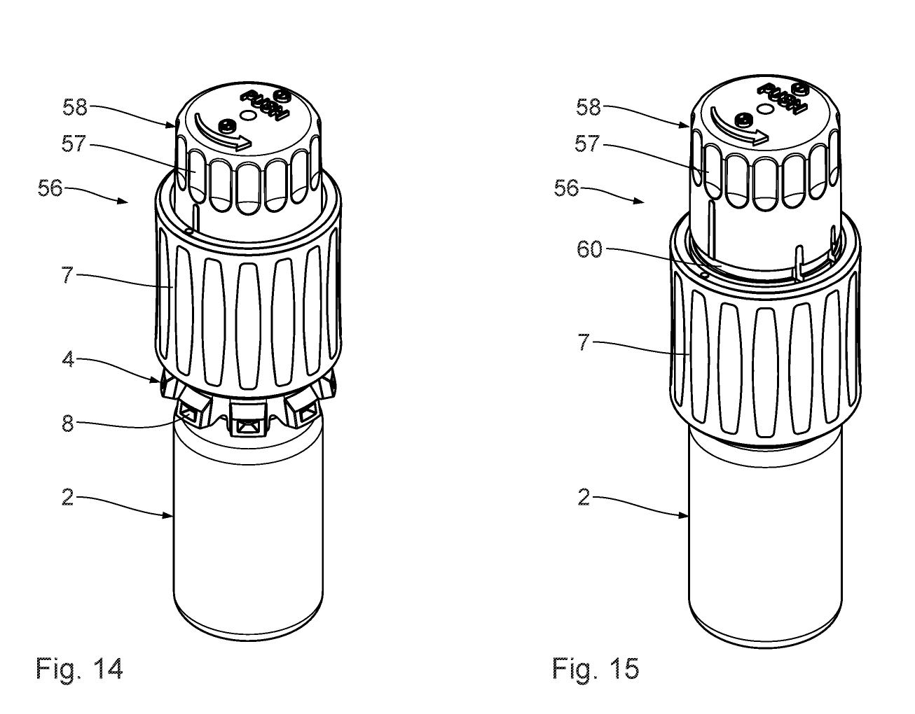

A further embodiment of a transfer apparatus 56, which can be used instead of the transfer apparatus 1 according to FIG. 1 to 13a/b, is described in the following text with reference to FIG. 14 et seq. Components and functions which correspond to those which have already been explained above with reference to FIG. 1 to 13a/b bear the same reference numerals or designations and are not discussed again in detail.

FIG. 14 shows the transfer apparatus 56 after being fitted on the storage container 2 and before the displacement of the seal securing sleeve 7.

FIG. 15 shows the transfer apparatus 56 after the displacement of the seal securing sleeve 7 into the securing position for the sealing portion 4.

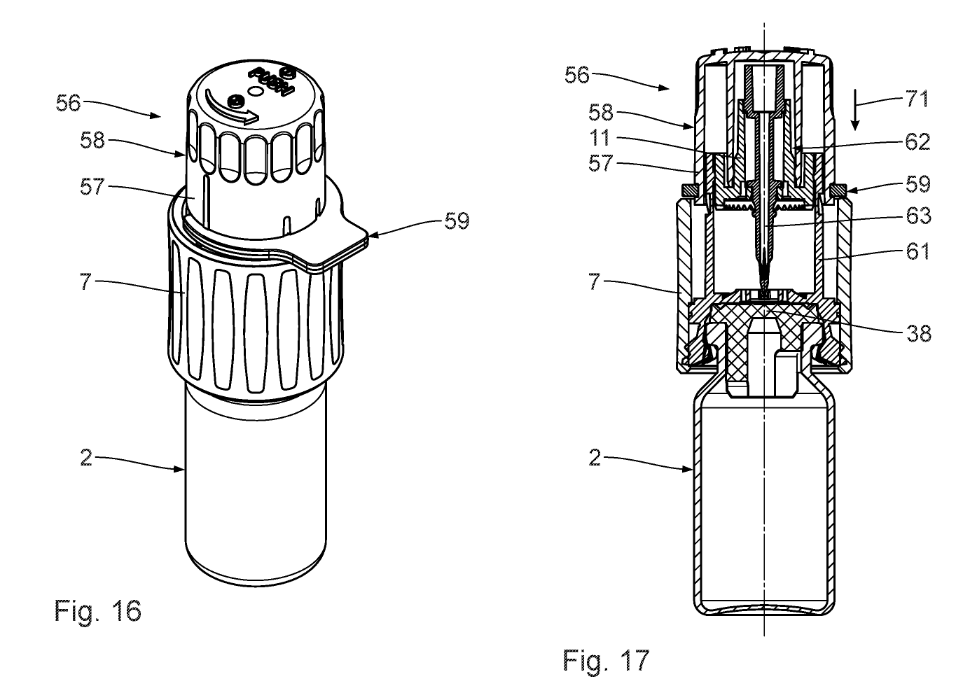

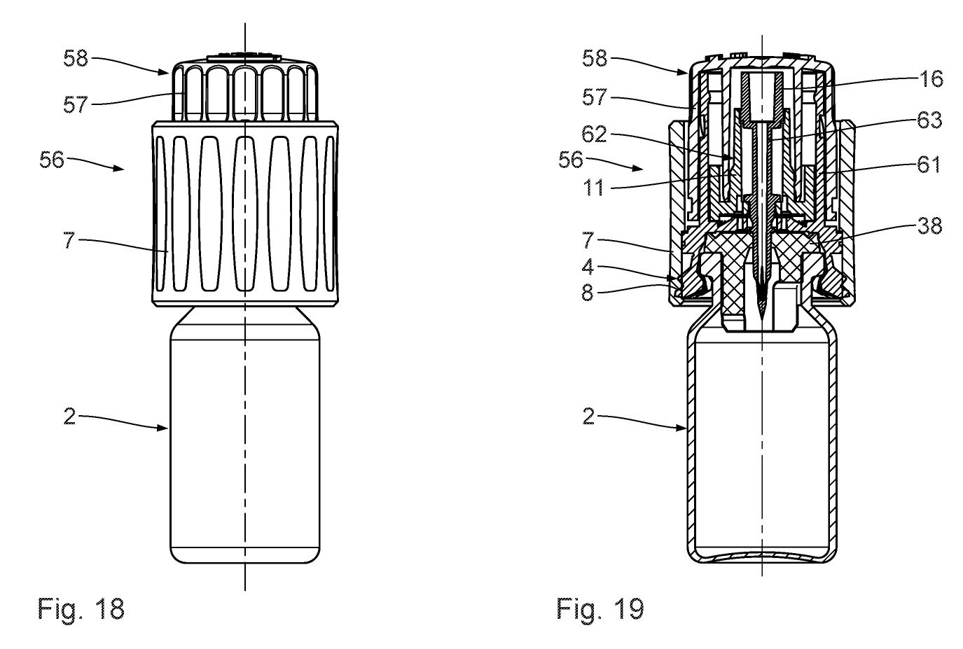

FIG. 16 shows the transfer apparatus 56 in a transport configuration. In this transport configuration, with the seal securing sleeve 7 pushed into the securing position, a removable securing element 59 in the form of a locking half ring is introduced between said seal securing sleeve 7 and a top portion 57 of a pressure-actuation element 58 of the transfer apparatus 56. The securing element 59 is pushed into a circumferential receiving groove 60 (cf. FIG. 15) in the top portion 57 of the pressure-actuation element 58. In this pushed-in position, the securing element 59 prevents the pressure-actuation element 58 from being displaced relative to a main body 61 (cf. FIG. 17) of the transfer apparatus 56 in the direction of the storage container 2. Unintentional pressure actuation of the pressure-actuation element 58 is thereby prevented.

With the securing element 59 removed, displacement of a hollow-needle assembly 62 with hollow needle 63 is possible between the rest position shown in FIG. 17 and the connecting position shown in FIG. 19 via the pressure-actuation element 58. During this displacement between the rest position and the connecting position, the pressure-actuation element 58 is rigidly connected to the hollow-needle assembly 62.

The hollow-needle assembly 62 is, apart from an external geometry of the needle sleeve 11, constructed in the same way as the hollow-needle assembly 9. The external geometry of the needle sleeve 11 in the embodiment according to FIG. 14 et seq. is embodied for a pushing movement and thus for example without the thread 27. In principle, the embodiment of the hollow-needle assembly 62 with regard to the liquid duct and the aeration gas duct is the same as has already been explained with respect to the hollow-needle assembly 9 in conjunction with FIG. 1 to 12.

For axial guidance of the pressure-actuation element 58 on the main body 61 during the displacement of the hollow-needle assembly 62 from the rest position into the connecting position, a guide device 64 is used. The latter has two guide pins 65 which are integrally formed on an inner side of a lateral wall of the pressure-actuation element 58. The guide pins 65 slide, during the displacement from the rest position into the connecting position, in in each case one associated guide groove 66 which is embodied in an outer wall of the main body 61 of the transfer apparatus 56.

The guide device 64 is configured such that the displacement of the hollow-needle assembly 62 from the rest position into the connecting position is irreversible.

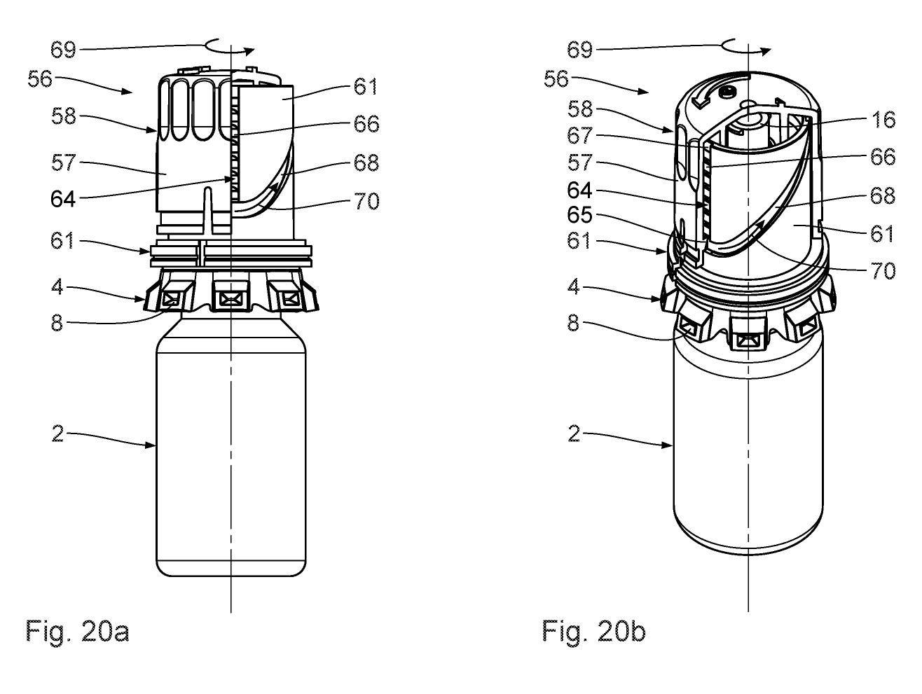

The two guide groove 66 each have a groove bottom 67 with a sawtooth profile, said groove bottom 67 being shown in cross section in FIG. 19 and in a perspective view in FIG. 20a/b for one of the two guide grooves 66. The profile of the sawteeth in the groove bottom 67 is such that the guide pins 65 can slide on inclined faces of the sawteeth during the displacement of the pressure-actuation element 58 from the rest position into the connecting position. In the connecting position, it is not possible for the guide pins 65 to slide back up in the guide grooves 66, since the guide pins 65 are then blocked by perpendicular faces of the sawtooth profile.

At their ends facing the storage container 2, the guide grooves 66 are each continued by a helical guide 68. Via these helical guides 68, once the connecting position has been reached, it is possible to unscrew the pressure-actuation element 58 from the main body 61 of the transfer apparatus 56, as is indicated by direction arrows 69, 70 in FIG. 20a/b. The guide pins 65 of the pressure-actuation element 58 in this case each slide in one of the two helical guides 68 on the outer side of the main body 61 of the transfer apparatus 56, until the guide pins 65 are disengaged from the main body 61 at the end of the helical guides 68.

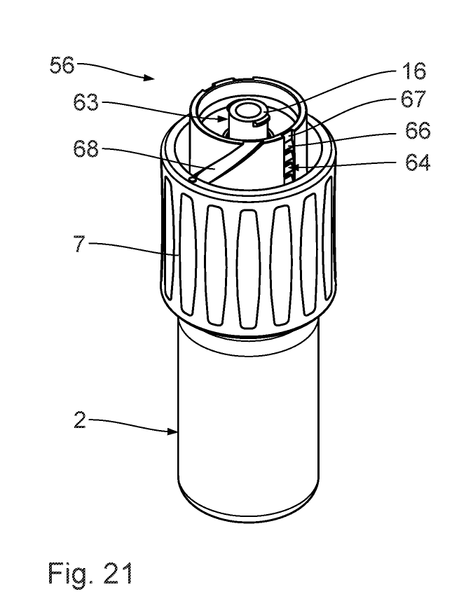

Following removal of the pressure-actuation element 58, the transfer apparatus 56 is in the instantaneous position which is shown in FIG. 21. In this instantaneous position, the connecting portion 16 of the hollow needle 63 is accessible from above, as has already been explained in conjunction with the transfer apparatus 1 and FIG. 6.

The transfer apparatus 56 is used as follows:

Once the assembly has taken place, the transfer apparatus 56, together with the storage container 2, in which the pulverulent medicine is stored, is initially in the transport position shown in FIG. 16 with the securing element 59 pushed in.

During use of the transfer apparatus 56, the securing element 59 is first of all pulled off. Then, pressure is exerted from above on an upper end face of the pressure-actuation element 58 and the pressure-actuation element 58 is transferred from the rest position into the connecting position along the direction arrow 71 in FIG. 17. In the process, the hollow needle 63 punctures the closure plug 38 of the storage container 2. During this displacement, the guide pins 65 rattle over the sawteeth in the groove bottoms 67 of the guide grooves 66 as far as the end, facing the storage container 2, of the guide grooves 66. The pressure-actuation element 58 can now be unscrewed from the main body 61 of the transfer apparatus 56, by being rotated in accordance with the direction arrow 69, such that the pressure-actuation element can be removed from the main body 61. The use container 3, i.e. the standard syringe, can now be connected to the connecting portion 16 via the Luer connector of said use container 3. The remaining handling operation is as described in conjunction with the embodiment according to FIG. 1 to 12.

1. An apparatus for transferring a liquid between a storage container and at least one further use container,
having a storage-container sealing portion for leaktight abutment of a main body of the transfer apparatus against the storage container;
having a hollow-needle assembly with a hollow needle, wherein the hollow-needle assembly is displaceable in a linear manner along a movement axis relative to the main body by means of a gear mechanism between
a retracted rest position and
an extended connecting position in which the hollow needle creates a liquid connecting duct between the storage container and the transfer apparatus,
having a connecting portion for connecting the transfer apparatus to the use container in a leaktight manner,
having a rotary-actuation element which is operatively connected to the hollow-needle assembly via the gear mechanism,
wherein the gear mechanism has a driver ring that is mounted in the main body axially and so as to be rotatable about the movement axis, said driver ring
interacting with a complementary thread of the hollow-needle assembly for the displacement of the hollow-needle assembly, and
being connected to the rotary-actuation element for conjoint rotation during the displacement.

2. The apparatus according to claim 1, wherein the driver ring has at least one inner driver which interacts with the complementary thread, embodied as an external thread, of the hollow-needle assembly.

3. The apparatus according to claim 1, comprising at least one axial lug via which the rotary-actuation element interacts with an axial receptacle in the driver ring in order to be connected for conjoint rotation.

4. The apparatus according to claim 1, wherein ribs on the main body, which belong to a device for preventing the hollow-needle assembly from rotating in the main body, simultaneously specify an axial seat of the driver ring.

5. An apparatus for transferring a liquid between a storage container and at least one further use container,
having a storage-container sealing portion for leaktight abutment of a main body of the transfer apparatus against the storage container,
having a hollow-needle assembly with a hollow needle, wherein the hollow-needle assembly is displaceable in a linear manner along a movement axis relative to the main body by means of a gear mechanism between
a retracted rest position and
an extended connecting position in which the hollow needle creates a liquid connecting duct between the storage container and the transfer apparatus,
having a connecting portion for connecting the transfer apparatus to the use container in a leaktight manner,
having a rotary-actuation element which is operatively connected to the hollow-needle assembly via the gear mechanism,
having a seal for sealing off the main body from the rotary-actuation element,
wherein the main body has a lifting driver which is embodied such that it interacts with a counterpart lifting driver, embodied in a complementary manner, on the rotary-actuation element in order that the rotary-actuation element is lifted off the main body in a manner relieving the seal during the rotary actuation of the rotary-actuation element.

6. The apparatus according to claim 5, wherein at least one of the group comprising the lifting driver and the counterpart lifting driver is embodied as a thread.

7. The apparatus according to claim 6, wherein the lifting driver is embodied as an external thread.

8. The apparatus according to claim 1, comprising a locking device for locking the hollow-needle assembly to the main body in the connecting position.

9. A set made up of a transfer apparatus according to claim 1 and a storage container.

10. A set made up of a storage container and a transfer apparatus according to claim 5.
